(19) United States
(12) Patent Application Publication
(10) Pub. No.: US 2025/0077243 A1
(43) Pub. Date: Mar. 6, 2025

(54) RANDOMIZATION OF INSTRUCTION EXECUTION FLOW FOR GLITCH PROTECTION

(71) Applicant: XILINX, INC., San Jose, CA (US)

(72) Inventors: Mohan Marutirao DHANAWADE, Hyderabad (IN); Ramakrishna Ganeshu POOLLA, Hyderabad (IN); Ahmad R. ANSARI, San Jose, CA (US)

(21) Appl. No.: 18/242,246

(22) Filed: Sep. 5, 2023

(51) Int. Cl. G06F 9/448

(52) U.S. Cl. CPC G06F 9/448

(57) ABSTRACT

Some examples described herein provide for instruction glitch protection in an integrated circuit. In an example, a method includes generating a random number by the integrated circuit. The method also includes identifying, based at least in part on the generated random number, a sequence from a set of sequences stored in a memory of the integrated circuit, each sequence of the set of sequences corresponding to an order of execution for a plurality of tasks. The method further includes performing, by the integrated circuit, each task of the plurality of tasks in the order of execution corresponding to the identified sequence.

### TECHNICAL FIELD

Examples of the present disclosure generally relate to instruction glitch protection, for example methods, apparatuses, and systems for randomization of instruction execution flow for glitch protection.

### BACKGROUND

Electronic integrated circuit (IC) devices (e.g., including chips and chip assemblies) may be subject to attack by adversaries. Such adversaries increasingly are able to mount sophisticated attacks on such electronic devices to break the security of the product. One such attack is a glitch attack. In such attacks, an adversary having sufficient electrical engineering knowledge can inject a momentary, high-voltage pulse onto a power rail of a target device. Ideally, the pulse is applied at a precisely-timed point while the target device is in an operational state. If the attack is successful, for example because the pulse is applied at the correct, precise time, a glitch can result. The resulting glitch can have a number of results vis-a-vis an instruction. A first result can be skipping the execution of a single instruction, for example leading to skipping authentication or other security checks in the code for the target device. A second result can be the corruption of data. A third result can be the incorrect decoding of the single instruction.

To address glitch attacks, one technique that can be used in a system that uses an electronic device includes adding one or more random delays in between the code (for example between two or more instructions of the code) that is performing a secure operation so that adversary cannot accurately time the attack on the target device (e.g., cannot precisely apply in time the high-voltage pulse). However, this technique includes a number of drawbacks or disadvantages. For example, inserting random delays adds delay (latency) in the execution of the instructions and, as such, may not be acceptable to time critical operations. Another drawback is that inserting random delays means that the overall execution time for a set of instructions will be not deterministic because random delays (or random time duration) are getting added to the code.

In light of at least these problems, improved glitch protection techniques are desired.

### SUMMARY

Some examples described herein provide for instruction glitch protection, for example methods, apparatuses, and systems for randomization of instruction execution flow for glitch protection.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method of instruction glitch protection in an integrated circuit. The method also includes generating a random number by the integrated circuit. The method also includes identifying, based at least in part on the generated random number, a sequence from a set of sequences stored in a memory of the integrated circuit, each sequence of the set of sequences corresponding to an order of execution for a plurality of tasks. The method also includes performing, by the integrated circuit, each task of the plurality of tasks in the order of execution corresponding to the identified sequence. Other embodiments of this aspect include corresponding computer systems, apparatus, and computer programs recorded on one or more computer storage devices, each configured to perform the actions of the methods.

One general aspect includes an apparatus of an integrated circuit. The apparatus also includes a memory to store a set of sequences, each sequence of the set of sequences corresponding to an order of execution for a plurality of tasks. The apparatus also includes one or more processors configured to: identify, based at least in part on a random number generated by the integrated circuit, a sequence from the set of sequences stored in the memory; and perform each task of the plurality of tasks in the order of execution corresponding to the identified sequence. Other embodiments of this aspect include corresponding computer systems, apparatus, and computer programs recorded on one or more computer storage devices, each configured to perform the actions of the methods.

One general aspect includes an apparatus for instruction glitch protection in an integrated circuit. The apparatus also includes a random number generator. The apparatus also includes one or more processors and one or more memories coupled with the random number generator, where the one or more memories store instructions that when executed by the processor cause the apparatus to: generate a random number; identify, based at least in part on the generated random number, a sequence from a set of sequences stored in a memory of the one or more memories, each sequence of the set of sequences corresponding to an order of execution for a plurality of tasks; and perform, by at least one of the one or more processors, each task of the plurality of tasks in the order of execution corresponding to the identified sequence. Other embodiments of this aspect include corresponding computer systems, apparatus, and computer programs recorded on one or more computer storage devices, each configured to perform the actions of the methods.

These and other aspects may be understood with reference to the following detailed description.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram depicting a computing system that includes a programmable integrated circuit (IC) and provides for randomization of instruction execution flow for glitch protection according to some examples.

FIG. 2 illustrates a field programmable gate array (FPGA) implementation, which provides for randomization of instruction execution flow for glitch protection according to some examples

FIG. 3 is a block diagram depicting a computing system that provides for randomization of instruction execution flow for glitch protection according to an example.

FIG. 4 is a flow diagram depicting a process that provides for randomization of instruction execution flow for glitch protection according to an example.

FIG. 5 is flow diagram of a method for instruction glitch protection in an integrated circuit, according to some examples.

FIG. 6 is flow diagram of a method for instruction glitch protection in an integrated circuit, according to some examples.

To facilitate understanding, identical reference numerals have been used, where possible, to designate identical elements that are common to the figures. It is contemplated that elements of one example may be beneficially incorporated in other examples.

### DETAILED DESCRIPTION

Some examples described herein provide for instruction glitch protection, for example methods, apparatuses, and systems for randomization of instruction execution flow for glitch protection. In one or more embodiments, an integrated circuit stores or accesses a stored set of sequences from memory (e.g., a read only memory (ROM)), where each sequence of the set of sequences is associated with (corresponds to) to an order of execution for a set of tasks (e.g., sets of instructions). For example a first sequence can correspond to an order of operation for eight tasks, while a second sequence can correspond to a different order of operation for the same eight tasks. The integrated circuit receives a request (command, instruction) to perform the set of tasks, and generates a random number. After generating the random number, the integrated circuit identifies a sequence from the set of sequences that corresponds to (maps to or is otherwise associated with) the generated random number. Having identified the sequence, the integrated circuit (e.g., a processor of the integrated circuit) performs each task of the set of tasks in the order of execution that corresponds to the identified sequence.

Selecting a sequence of tasks from a set of sequences according to a generated random number provides randomization of an execution flow (e.g., a sequence of the set of tasks) so that an adversary (attacker) does not know which part of the secure code is getting executed (e.g., which task is being performed at a particular time due to the random sequence) and thus the adversary cannot easily mount an attack (e.g., glitch attack) on the electronic device. The embodiments described herein may also provide an advantage (benefit) that the total execution time for the set of tasks remains constant, even if the order of execution according to the sequence is selected randomly. For example, in some application, the described embodiments can allow for increased protection against glitch attacks for devices (e.g., integrated circuits) where operation is time critical for the set of tasks (e.g., latency is subject to a time constraint, or latency is required to be relatively low relative to a threshold). In some applications, the techniques described herein for protection against glitch attacks can be used where existing techniques (e.g., inserting a random time duration between operation of tasks of the set of tasks) fail or are otherwise inadequate or unavailable.

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the claimed invention or as a limitation on the scope of the claimed invention. In addition, an illustrated example need not have all the aspects or advantages shown. An aspect or an advantage described in conjunction with a particular example is not necessarily limited to that example and can be practiced in any other examples even if not so illustrated or if not so explicitly described.

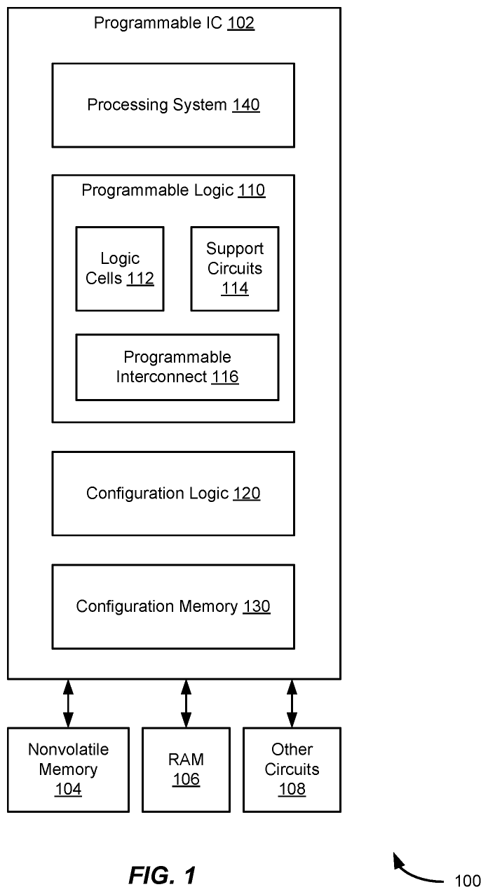

FIG. 1 is a block diagram depicting a computing system 100 that includes a programmable integrated circuit (IC) 102 and provides for randomization of instruction execution flow for glitch protection according to some examples. The programmable IC 102 includes programmable logic 110, configuration logic 120, and configuration memory 130. The programmable IC 102 can be coupled to external circuits, such as the nonvolatile memory (NVM) 104, the random access memory (RAM) 106, and other circuits 108. In some examples, RAM 106 may be dynamic random access memory (DRAM).

The programmable logic 110 includes logic cells 112, support circuits 114, and programmable interconnect 116. The logic cells 112 include circuits that can be configured to implement general logic functions of a plurality of inputs. The support circuits 114 include dedicated circuits, such as transceivers, input/output blocks, digital signal processors, memories, and the like. The logic cells 112 and the support circuits 114 can be interconnected using the programmable interconnect 116. Information for programming the logic cells of programmable logic 110, for setting parameters of the support circuits 114, and for programming the programmable interconnect 116 is stored in the configuration memory 130 by the configuration logic 120. The configuration logic 120 can obtain the configuration data from the nonvolatile memory 104 or any other source (e.g., the RAM 106 or from the other circuits 108).

In some examples, the programmable IC 102 is a part of a computing system and is communicatively coupled with a processing system (not shown) of the computing system that is external to the programmable IC 102. The external processing system can include microprocessor(s), memory, support circuits, input/output (I/O) circuits, and the like. In other examples, the processing system 140 can be used in place of at least some of the external processing system for the computing system. The programmable IC 102 can be part of the computing system, and the programmable IC 102 can include the processing system 140 as part of the programmable IC 102, such that the programmable IC 102 includes one or more of the microprocessor(s), memory, support circuits, I/O circuits, and the like. In some example, the entire computing system can be implemented using the programmable IC 102.

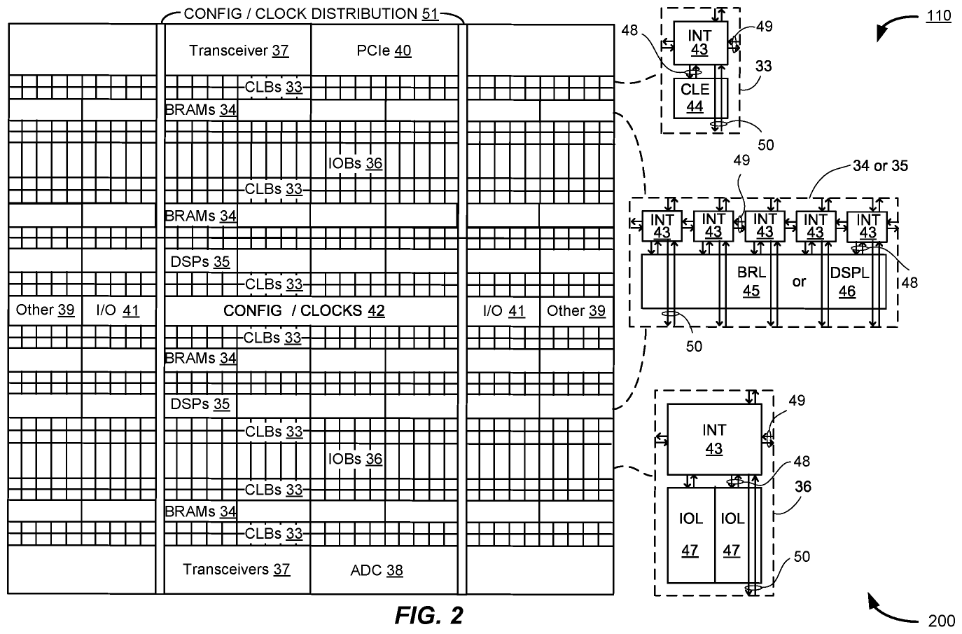

FIG. 2 illustrates a field programmable gate array (FPGA) implementation 200 of at least portions of the programmable IC 102 (e.g., programmable logic 110), which provides for randomization of instruction execution flow for glitch protection according to some examples. In one or more examples, the programmable IC 102 that includes a large number of different programmable tiles including transceivers 37, configurable logic blocks (CLBs) 33, block random access memories (BRAMs) 34, input/output blocks (“IOBs”) 36, configuration and clocking logic (“CONFIG/CLOCKS”) 42, digital signal processor (DSP) blocks 35, specialized input/output blocks (“I/O”) 41 (e.g., configuration ports and clock ports), and other programmable logic 39 such as digital clock managers, analog-to-digital converters, system monitoring logic, and so forth. The FPGA can also include peripheral component interconnect (PCI) express (PCIe) interfaces 40, analog-to-digital converters (ADCs) 38, and the like.

In some FPGAs, each programmable tile can include at least one programmable interconnect element (“INT”) 43 having connections to input and output terminals 48 of a programmable logic element within the same tile, as shown by examples included at the top of FIG. 2. Each programmable interconnect element 43 can also include connections to interconnect segments 49 of adjacent programmable interconnect element(s) in the same tile or other tile(s). Each programmable interconnect element 43 can also include connections to interconnect segments 50 of general routing resources between logic blocks (not shown). The general routing resources can include routing channels between logic blocks (not shown) comprising tracks of interconnect segments (e.g., interconnect segments 50) and switch blocks (not shown) for connecting interconnect segments. The interconnect segments of the general routing resources (e.g., interconnect segments 50) can span one or more logic blocks. The programmable interconnect elements 43 taken together with the general routing resources implement a programmable interconnect structure (“programmable interconnect”) for the illustrated FPGA.

In an example implementation, a CLB 33 can include a configurable logic element (“CLE”) 44 that can be programmed to implement user logic plus a single INT 43. A BRAM 34 can include a BRAM logic element (“BRL”) 45 in addition to one or more programmable interconnect elements. Typically, the number of interconnect elements included in a tile depends on the height of the tile. In the pictured example, a BRAM tile has the same height as five CLBs, but other numbers (e.g., four) can also be used. A DSP tile 35 can include a DSP logic element (“DSPL”) 46 in addition to an appropriate number of programmable interconnect elements. An IOB 36 can include, for example, two instances of an input/output logic element (“IOL”) 47 in addition to one instance of the programmable interconnect element 43. As will be clear to those of skill in the art, the actual I/O pads connected, for example, to the I/O logic element 47 typically are not confined to the area of the input/output logic element 47.

In the pictured example of the FPGA implementation 200, a horizontal area near the center of the die is used for configuration, clock, and other control logic. Vertical columns 51 extending from this horizontal area or column are used to distribute the clocks and configuration signals across the breadth of the FPGA implementation 200.

Some examples of FPGAs utilizing the architecture illustrated by the FPGA implementation 200 include additional logic blocks that disrupt the regular columnar structure of the FPGA implementation 200. The additional logic blocks can be programmable blocks and/or dedicated logic.

Note that the FPGA implementation 200 is intended to illustrate only an exemplary FPGA architecture. For example, the numbers of logic blocks in a row, the relative width of the rows, the number and order of rows, the types of logic blocks included in the rows, the relative sizes of the logic blocks, and the interconnect/logic implementations included at the top of the illustrated FPGA implementation 200 are purely exemplary. For example, in an actual implementation of an FPGA, more than one adjacent row of CLBs is typically included where the CLBs appear, to facilitate the efficient implementation of user logic, but the number of adjacent CLB rows can vary with the overall size of the FPGA.

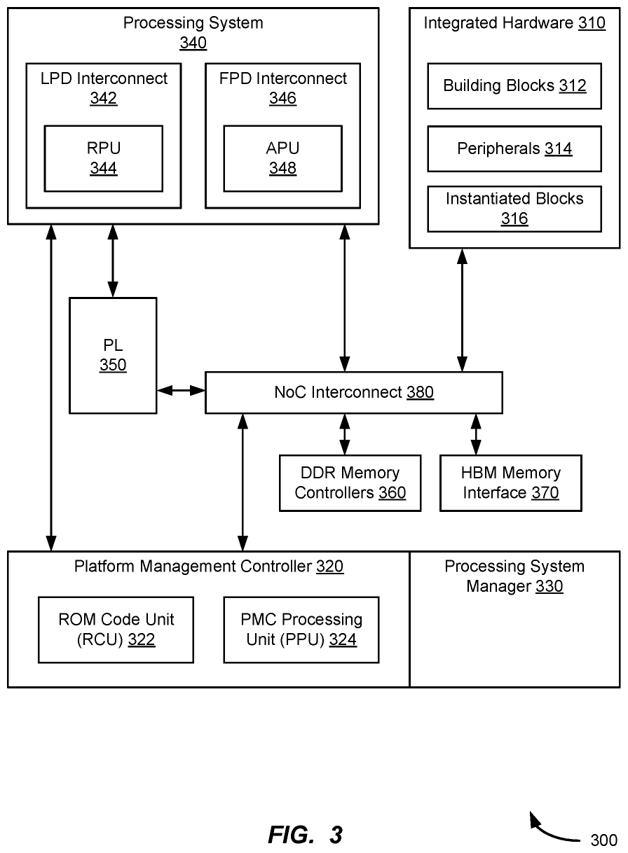

FIG. 3 is a block diagram depicting a computing system 300 that provides for randomization of instruction execution flow for glitch protection according to an example. In one or more embodiments, computing system 300 includes integrated hardware 310, a platform management controller 320, a processing system manager 330, a processing system 340, programmable logic 350, a double data rate (DDR) memory controller 360, a high bandwidth memory (HBM) interface 370, and network on chip (NoC) interconnect 380. In one or more embodiments, processing system 340 is an example of a processing system 140, or programmable logic 350 is an example of programmable logic 110, or both.

The integrated hardware 310 includes building blocks 312, peripherals 314, and instantiated blocks 316. In one or more embodiments, building blocks 312 include one or more circuits for digital signal processors (DSPs), logic blocks, RAM, or input-output pins. In one or more embodiments, peripherals 314 include one or more circuits for Ethernet (e.g., media access control (MAC) layers), or chip-to-chip interconnect protocols for high speed networks. Instantiated blocks 316 include one or more circuits for soft processor cores and instruction set for embedded applications, associated interconnect, pipeline slides, or functional units.

The platform management controller (PMC) 320 is responsible for platform management tasks such as boot, configuration, partial reconfiguration, and other platform management tasks, such as security. The PMC 320 includes the deeply embedded ROM code unit (RCU) 322 for device boot. The PMC 320 also includes a platform processing unit (PPU) 324 that executes a platform loader and manager (PLM) firmware. The PMC 320 also manages the processing system management (PSM) controller firmware downloads for the PSM 330. The PSM 330 runs firmware that has been downloaded by the PMC 320.

Processing system 340 includes a real-time processing unit (RPU) 344 in a low power domain coupled within the processing system 340 via low-power domain (LPD) interconnect 342. Processing system 340 also includes an application processing unit (APU) 348 in a full power domain coupled within the processing system 340 via full-power domain (FPD) interconnect 346.

In one or more embodiments, RPU 344 includes one or more processing cores that can operate in a lock-step mode for increased safety, or a dual processor mode for increase performance. RPU 344 provides predicable software execution time. In some examples, each processor core includes L1 instruction and data caches and one or more banks of tightly coupled memories (TCMs) to narrow down the deterministic behavior for real-time data processing application. The RPU can provide deterministic execution times for real-time applications by operating out of the TCMs, and can execute instructions and access data from the TCMs, a DDR memory (e.g., via DDR memory controller 360), or other system memories.

In one or more embodiments, APU 348 includes one or more processing cores that provide general-purpose computing. The APU processors can be used for computations, control-plane applications, operating systems, communications interfaces, and the like.

The programmable logic 350 is a scalable structure that provides the ability to create different functions. The integrated hardware options have interconnect interfaces and connections to the fabric of programmable logic 350. In some embodiments, the input/output for the programmable logic 350 includes one or both of low voltage complementary metal oxide semiconductor (LVCMOS) buffers or gigabit transceivers that cover a wide range of applications and frequencies.

In one or more embodiments, the DDR memory controller 360 controls a RAM (e.g., an external RAM, such as external to a block, chip, or module that includes the circuit implementing the DDR memory controller 360) such as a RAM 106.

In one or more embodiments, the HBM interface 370 provides an interface to an HBM memory (e.g., an external HBM, such as external to a block, chip, or module that includes the circuit implementing the HBM interface 370). In some embodiments, the HBM memory can be a 3D-stacked synchronous dynamic random-access memory (SDRAM).

The network on chip (NoC) interconnect 380 communicatively couples (connects, links) the integrated hardware 310, the platform management controller 320, the processing system manager 330, the processing system 340, the programmable logic 350, the DDR memory controller 360, the HBM interface 370, and other circuits (blocks, modules, components) of the computing system 300. In one or more embodiments, the NoC interconnect is pervasive across the computing system 300.

In one or more embodiments, the computing system 300 is or is implemented as a system on chip (SoC). In one or more embodiments, the computing system 300 is or is implemented as a heterogeneous integration circuitry. In some embodiments, the computing system 300 is, is part of, or includes an adaptive compute acceleration platform (ACAP).

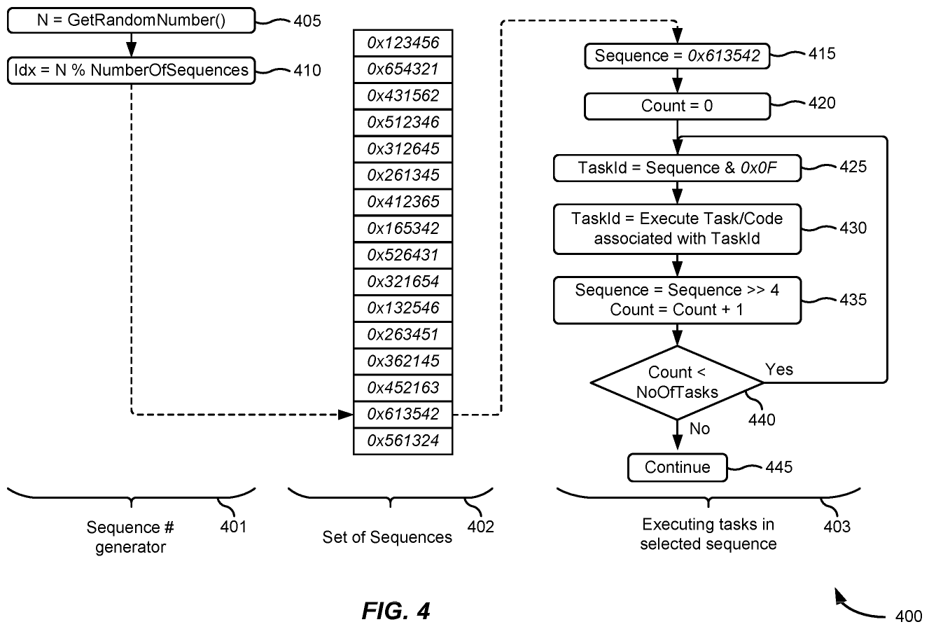

FIG. 4 is a flow diagram depicting a process 400 that provides for randomization of instruction execution flow for glitch protection according to an example. Process 400 includes a first portion 401 for sequence number generation, a second portion 402 for predefined sequences identification and retrieval, and a third portion 403 for executing tasks according to the identified (selected, determined) sequence.

For the first portion 401 of process 400, at 405, process 400 includes generating a random number, N, for example according to a random number function GetRandomNumber( ). In some embodiments, the random number is a true random number. In other embodiments, the random number is a pseudo-random number. In one or more embodiments, the random number is obtained (e.g., by getting, reading, fetching, obtaining) from a random number generator that is a part of or incorporated with the computing system (e.g., on a same chip, or heterogeneous integration circuitry), such as computing system 100 or computing system 300. The random number is used to randomize the execution flow for a set or two or more (multiple, plurality) of tasks. In some embodiments, the random number has a size of one byte (eight bits). In other embodiments, the random number can have a different number of bits, or otherwise be selected to have a different size.

At 410, a sequence from a set of sequences is identified based on the random number generated at 405. In some embodiments, the set of sequences are predefined. For example, the set of sequences can be determined (identified, obtained) and stored in memory (e.g., by a designer of the computing system that will utilize process 400), prior to generating the random number and using the set of sequences during process 400. In one or more embodiments, a modulus function is used to identify an index value, which indicates a sequence from the set of sequence. For example, the function can be Idx=N % NumberOfSequences, where Nis the generated random number at 405 and NumberOfSequences is the number of sequences in the set of sequences. Idx is then the index associated with a sequence of the set of sequences. In an example, the code is performing six independent tasks (e.g., there are six tasks whose order is to be randomized), and the sequence of execution is unimportant (e.g., each task could be performed before or after each other task without impact) but executing all the tasks is important. The random number generator provides a random number of size at least 1-byte. In this example where there are six tasks, then there are 6!=720 combinations of task execution (720 possible sequence orders for the set of sequences). These sequences (e.g., the superset of sequences) can be selected to be included in the set of sequences, or the set of sequences can be selected as a subset of sequences from the superset of sequences.

In one or more embodiments, the set of sequences (e.g., combinations of tasks, whether the full superset, or the subset of the superset) can be selected (chosen, determined, generated) and stored in an array (e.g., memory). In one or more embodiments, the sequences for the set of sequences are selected from the superset of sequences based on a hamming distance between the sequences such that the selected sequences have a proper hamming distance.

The second portion 402 of process 400 illustrates an exemplary set of sequences. For example, sixteen random sequences are the set of sequences as illustrated with reference to the second portion 402. Random Sequences=0x123456, 0x654321, 0x431562, 0x512346, 0x312645, 0x261345, 0x412365, 0x165342, 0x526431, 0x321654, 0x132546, 0x263451, 0x362145, 0x452163, 0x613542, 0x561324. In one or more embodiments, for sixteen combination, the random number generated can be 1 byte of 8-bits (corresponding to 256 different values). Such random number is generated at 405, and the modulus function used at 410 to determine (identify, generate) an index used to pick (select, identify, determine) a sequence (random sequence) from the set of sequences (random number % 16+1). For example, if the random number generated is 255, the index is (254% 16)+1=15. The 15^{th} element from the random sequences (i.e., 0x613542 as illustrated in second portion 402) is identified (selected) as input to the third portion 403 of process 400. The sequence, previously stored in the array (memory), are read (fetched) from the array (memory). In one or more embodiments, the array is or is a portion of ROM of an integrated circuit performing the process 400. In some embodiments,

The third portion 403 of process 400 illustrates an embodiment where a nibble is extracted from right to left one by one from the selected random sequence (at 415), and the task/code associated with number in that nibble is executed. In the example where the selected sequence is 0x613542, the tasks are executed (performed) in the order of task 2, followed by task 4, followed by task 5, followed by task 3, followed by task 1, followed finally by task 6.

The selected sequence is at 415. Beginning at a count of 0 at 420, each task is performed in order. In some embodiments, bits are added to the TaskId at 425 for execution. In other embodiments, such as different systems and implementations, adding bits is omitted. The task/code associated with the TaskId is executed at 430. At 435, the bits of the sequence are shifted by four bits and the count is increased by one. At 440, if the count of tasks is less than the number of tasks, the process 400 returns to 425 to execute a next task indicated by the sequence. At 440, if the count of tasks has reaches the total number of tasks, the process 400 is complete for task execution according to the sequence and the integrated circuit performing the process 400 continues at 445 to other operations. For example, in one or more embodiments, process 400 is performed is connection with a boot procedure for a processor unit (e.g., one or more processor or processor units of computing system 100 or computing system 300).

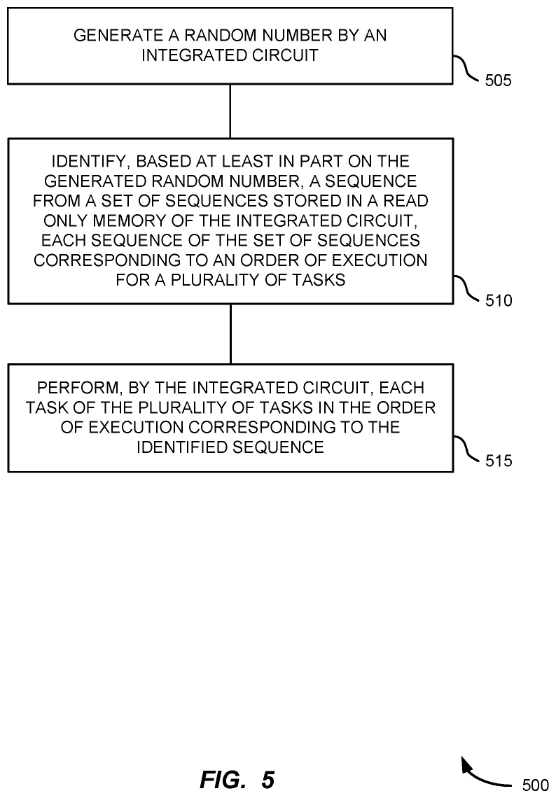

FIG. 5 is flow diagram of a method 500 for instruction glitch protection in an integrated circuit, according to some examples. In one or more embodiments, one or more steps of method 500 are performed by a processor of processing system 140 or a processor of processing system 340 (e.g., RPU 344, APU 348, RCU 322, PPU 324). In some embodiments, a combination of processors of processing system 140 and/or processing system 340 (e.g., a combination of RPU 344, APU 348, RCU 322, PPU 324) perform the steps of method 500.

At block 505, method 500 includes generating a random number by the integrated circuit. In one or more embodiments, block 505 is performed by one or more circuits of computing system 100 (e.g., programmable IC 102) or computing system 300, such that the integrated circuit is or includes all or portions of computing system 100 and/or computing system 300. In some embodiments, block 505 is performed by the processing system 140 or processing system 340, such as a random number generator circuit of processing system 140 or processing system 340.

At block 510, method 500 includes identifying, based at least in part on the generated random number, a sequence from a set of sequences stored in a ROM of the integrated circuit. Each sequence of the set of sequences corresponds to an order of execution for a plurality of tasks.

In one or more embodiments, block 505 is performed by one or more circuits of computing system 100 (e.g., programmable IC 102) or computing system 300. In some embodiments, the set of sequences are stored in a ROM of processing system 140 or processing system 340.

At block 515, method 500 includes performing, by the integrated circuit, each task of the plurality of tasks in the order of execution corresponding to the identified sequence.

In one or more embodiments, two or more of operations of method 500 are substantially performed concurrently (simultaneously), or in a different order.

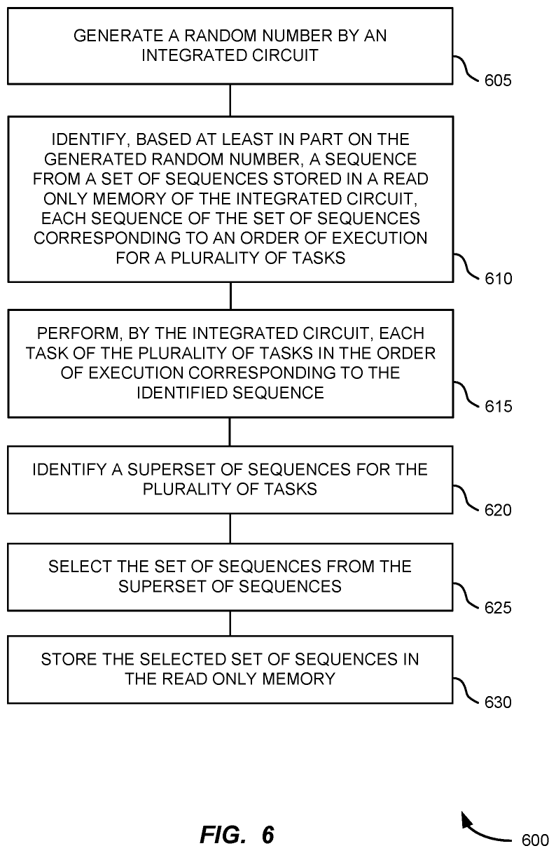

FIG. 6 is flow diagram of a method 600 for instruction glitch protection in an integrated circuit, according to some examples. In one or more embodiments, one or more steps of method 600 (e.g., block 605, 610, 615, 620, 625, 630) is performed by one or more circuits of computing system 100 (e.g., programmable IC 102) or computing system 300, such that the integrated circuit is or includes all or portions of computing system 100 and/or computing system 300. In one or more embodiments, one or more steps of method 600 are performed by a processor of processing system 140 or a processor of processing system 340 (e.g., RPU 344, APU 348, RCU 322, PPU 324). In some embodiments, a combination of processors of processing system 140 and/or processing system 340 (e.g., a combination RPU 344, APU 348, RCU 322, PPU 324) perform the steps of method 600. In some embodiments, PPU 324 performs one or more steps of method 600, including at least blocks 610 and 615.

At block 605, method 600 includes generating a random number by the integrated circuit. In one or more embodiments, the random number is a pseudo-random number. In some embodiments, the random number is a true random number.

At block 610, method 600 includes identifying, based at least in part on the generated random number, a sequence from a set of sequences stored in a ROM of the integrated circuit. Each sequence of the set of sequences corresponds to an order of execution for a plurality of tasks.

At block 615, method 600 includes performing, by the integrated circuit, each task of the plurality of tasks in the order of execution corresponding to the identified sequence.

At block 620, method 600 includes identifying a superset of sequences for the plurality of tasks.

At block 625, method 600 includes selecting the set of sequences from the superset of sequences.

At block 630, method 600 includes storing the selected set of sequences in the read only memory.

In one or more embodiments, method 600 is performed at a processor of the computing system 100 or the computing system 300 (e.g., RPU 344, APU 348, RCU 322, PPU 324) in response to a request (e.g., a service request) received from another process of the computing system 100 or computing system 300 (e.g., RPU 344, APU 348, RCU 322, PPU 324). In some embodiments, method 600 is self-initiated by the processor (e.g., RPU 344, APU 348, RCU 322, PPU 324). For example, method 600 can further include receiving, at a first processor of the integrated circuit, a service request from a second processor of the integrated circuit, wherein each task of the plurality of tasks is performed by the first processor responsive to the service request.

In one or more embodiments, two or more of operations of method 600 are substantially performed concurrently (simultaneously), or in a different order.

In one or more embodiments, one or more operations of method 500 may be combined with one or more operations of method 600.

While the foregoing is directed to specific examples, other and further examples may be devised without departing from the basic scope thereof, and the scope thereof is determined by the claims that follow.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of instruction glitch protection in an integrated circuit, comprising:
generating a random number by the integrated circuit;
identifying, based at least in part on the generated random number, a sequence from a set of sequences stored in a memory of the integrated circuit, each sequence of the set of sequences corresponding to an order of execution for a plurality of tasks; and
performing, by the integrated circuit, each task of the plurality of tasks in the order of execution corresponding to the identified sequence.

2. The method of claim 1, further comprising:
receiving, at a first processor of the integrated circuit, a service request from a second processor of the integrated circuit, wherein each task of the plurality of tasks is performed by the first processor responsive to the service request.

3. The method of claim 1, further comprising:
identifying a superset of sequences for the plurality of tasks;
selecting the set of sequences from the superset of sequences; and
storing the selected set of sequences in the memory.

4. The method of claim 3, wherein the superset of sequences corresponds to all possible combinations of orders of execution for the plurality of tasks.

5. The method of claim 1, wherein each sequence of the set of sequences corresponds to an order for performing the plurality of tasks that is different from each other sequence of the set of sequences.

6. The method of claim 1, wherein performing, each task of the plurality of tasks in the order of execution corresponding to the identified sequence further comprises:
waiting a time duration between two or more of the tasks of the plurality of tasks, wherein the time duration is random or pseudo-random.

7. The method of claim 1, wherein each task of the plurality of tasks is performed immediately following a prior task of the plurality of tasks.

8. The method of claim 1, wherein the plurality of tasks comprise one or more tasks associated with booting a set of circuitry of the integrated circuit.

9. An apparatus of an integrated circuit, comprising:
a memory to store a set of sequences, each sequence of the set of sequences corresponding to an order of execution for a plurality of tasks; and
one or more processors configured to:
identify, based at least in part on a random number generated by the integrated circuit, a sequence from the set of sequences stored in the memory; and
perform each task of the plurality of tasks in the order of execution corresponding to the identified sequence.

10. The apparatus of claim 9, wherein the one or more processors comprise a first processor configured to:
receive a service request from a second processor, wherein each task of the plurality of tasks is performed by the first processor responsive to the service request.

11. The apparatus of claim 9, wherein the one or more processors are further configured to:
identify a superset of sequences for the plurality of tasks;
select the set of sequences from the superset of sequences; and
store the selected set of sequences in the memory.

12. The apparatus of claim 11, wherein the superset of sequences corresponds to all possible combinations of orders of execution for the plurality of tasks.

13. The apparatus of claim 9, wherein each sequence of the set of sequences corresponds to an order for performing the plurality of tasks that is different from each other sequence of the set of sequences.

14. The apparatus of claim 9, wherein the one or more processors are further configured to:
wait a time duration between two or more of the tasks of the plurality of tasks, wherein the time duration is random or pseudo-random.

15. The apparatus of claim 9, wherein each task of the plurality of tasks is performed immediately following a prior task of the plurality of tasks.

16. The apparatus of claim 9, wherein the plurality of tasks comprise one or more tasks associated with booting a set of circuitry of the integrated circuit.

17. An apparatus for instruction glitch protection in an integrated circuit, comprising:
a random number generator; and
one or more processors and one or more memories coupled with the random number generator, wherein the one or more memories store instructions that when executed by the processor cause the apparatus to:
generate a random number;
identify, based at least in part on the generated random number, a sequence from a set of sequences stored in a memory of the one or more memories, each sequence of the set of sequences corresponding to an order of execution for a plurality of tasks; and
perform, by at least one of the one or more processors, each task of the plurality of tasks in the order of execution corresponding to the identified sequence.

18. The apparatus of claim 17, wherein the one or more memories further store instructions to:
receive, at a first processor of the one or more processors, a service request from a second processor of the one or more processors, wherein each task of the plurality of tasks is performed by the first processor responsive to the service request.

19. The apparatus of claim 17, wherein the one or more memories further store instructions to:
identify a superset of sequences for the plurality of tasks;
select the set of sequences from the superset of sequences; and
store the selected set of sequences in the one or more memories.

20. The apparatus of claim 17, wherein each sequence of the set of sequences corresponds to an order for performing the plurality of tasks that is different from each other sequence of the set of sequences.

21. The apparatus of claim 17, wherein the one or more memories further store instructions to:
wait a time duration between two or more of the tasks of the plurality of tasks, wherein the time duration is random or pseudo-random.
